(19) United States
(12) Patent Application Publication
(10) Pub. No.: US 2008/0078599 A1
(43) Pub. Date: Apr. 3, 2008

(54) VEHICLE AND METHOD FOR INSPECTING A SPACE

(75) Inventor: Jeffrey A. DeRocher, Prairieville, LA (US)

Correspondence Address: Erika S. Wilson;c/o Honeywell International Inc., 101 Columbia Road, P. O. Box 2245, Morristown, NJ, 07962, US

(73) Assignee: HONEYWELL INTERNATIONAL INC., Morris Township, NJ (US)

(21) Appl. No.: 11/537,174

(22) Filed: Sep. 29, 2006

(51) Int. Cl. B60B 39/00

(52) U.S. Cl. 180/164

(57) ABSTRACT

A vehicle for use in inspecting a space and which can be operated from a remote location. The vehicle includes a chassis; at least three wheels rotatably mounted to and on which the chassis is moveable; a transmission mounted to the chassis and operatively connected to at least a first one of the wheels for rotating the first wheel; and a rotatable flexible drive shaft having a first end operatively connectable to the transmission and a second end operatively connectable to a motor for rotating the flexible drive shaft and thereby move the vehicle over a surface. Also provided is a method for inspecting a space.

### BACKGROUND OF THE INVENTION

The present invention relates to vehicles, and more particularly to vehicles that can be remotely operated.

There are numerous fields of industry where the need arises to perform a task inside of a space that is, or could be, too hazardous for personnel to enter safely. Such spaces can generally be grouped into three broad categories.

The first category consists of spaces that are too small, hot, radioactive, or otherwise dangerous for a human being to safely enter, even with protective equipment. Examples include the inside of small pipes, unstable excavations, and nuclear devices.

The second category is comprised of spaces that can be safely entered, but only at significant economic cost. Examples include oxygen deficient atmospheres, commercial diving applications, and vessels with dangerous residual chemicals.

The third category, and statistically most dangerous category, is any confined space which is believed to have an atmosphere suitable for unprotected entry, and is large enough for a person to access, but may potentially contain an undetected and dangerous substance. Examples include an improperly cleaned railcar with hazardous vapors, an improperly isolated vessel with insufficient oxygen to sustain life, and an excavation where heavier than air gases may accumulate in deeper sections.

For many of these situations, particularly those in the third category, a worker wearing a protective suit and fresh air equipment must enter the vessel, and use a portable detector to verify that the atmosphere throughout the space is safe for unprotected entry. This method presents a potentially serious risk to the first worker. Should the worker injure him or herself, or lose consciousness, the ability to execute a timely rescue of a person wearing bulky protective gear from a confined space is marginal at best. A much preferred approach is to use a remote vehicle to draw air samples from throughout the vessel and then analyze those samples using equipment and a technician safely located in a remote location outside the space.

Numerous remotely controlled vehicles have been developed to assist with this application. Alternatively, they may be outfitted with cameras for visual inspection, testing equipment for ultrasonic thickness measurement, or other suitable tools for specific tasks. Units are commercially available with electrical, pneumatic, or hydraulic power and are driven by wheels or caterpillar-style treads. Each of these has relative advantages in particular circumstances, but they share several disadvantages in that they are expensive to purchase, difficult to learn to operate, easily damaged, and generally not field maintainable. Electrical devices may also not be suitable in explosive, hot, or underwater environments. Hydraulic units are powerful, but pose an environmental risk in the event of a hydraulic fluid leak. Pneumatic units are generally loud and require a source of compressed gas.

Accordingly, there is a need for an improved vehicle and method for inspecting spaces.

### SUMMARY OF THE INVENTION

In one form, the invention provides a vehicle for use in inspecting a space and which can be operated from a remote location. One preferred embodiment of such vehicle includes a chassis and at least three wheels rotatably mounted to and on which the chassis is moveable over a surface. A transmission is mounted to the chassis and is operatively connected to at least a first one of the wheels for rotating the first wheel. A rotatable flexible drive shaft is provided which has one end operatively connectable to the transmission for driving the transmission to rotate the first wheel, and a second end operatively connectable to a motor for rotating the flexible drive shaft and thereby move the vehicle over the surface. The flexible drive shaft has sufficient length to drive the vehicle in the space from the remote location.

In another form, the invention provides a method for inspecting a space. One such form includes the steps of (a) placing a vehicle within the space, the vehicle having wheels for moving over a surface within the space, a transmission operatively connected to at least a first one of the wheels; (b) providing a rotatable flexible drive shaft operatively connected to the transmission for driving the vehicle, the drive shaft having a length sufficient to operate the vehicle within the space from a location remote from the space; and (c) moving the vehicle within the space by rotating the flexible drive shaft from the remote location to drive the first wheel and carry out the inspection.

Other forms of a vehicle in accordance with the present invention include magnets mounted to the vehicle for maintaining the vehicle in contact with the surface through magnetic force, and a second rotatable flexible drive shaft connectable to the vehicle to provide the capability of steering the vehicle.

### BRIEF DESCRIPTION OF THE DRAWINGS

The following detailed description will be better understood when read in conjunction with the figures appended hereto. For the purpose of illustrating the invention, there is shown in the drawings two presently preferred embodiments. It is understood, however, that this invention is not limited to these embodiments of the precise arrangements shown.

FIG. 1 is a perspective view of a first embodiment of the invention showing a vehicle driven by a single drive shaft;

FIG. 1A is a top view of the vehicle shown in FIG. 1;

FIG. 1B is a side view of the vehicle shown in FIG. 1;

FIG. 1C is an end view of the vehicle shown in FIG. 1;

FIG. 2 is a top view of the second embodiment of the invention showing a vehicle driven by two drive shafts;

FIG. 2A is an end view of the vehicle shown in FIG. 2;

FIG. 3 is an illustration of a vehicle in accordance with the present invention inside a rail tank car; and

FIG. 4 is an illustration of a first vehicle in accordance with the present invention inside a rail tank car and a second vehicle on the outside of said tank magnetically attracted to the first vehicle.

### DETAILED DESCRIPTION OF THE INVENTION

The following detailed description of the invention is merely exemplary in nature and is not intended to limit the invention or the application and uses of the invention. Reference will now be made in detail to exemplary embodiments of the invention, examples of which are illustrated in the accompanying drawings. Wherever possible, the same reference numbers will be used throughout the drawings to refer to the same or like parts.

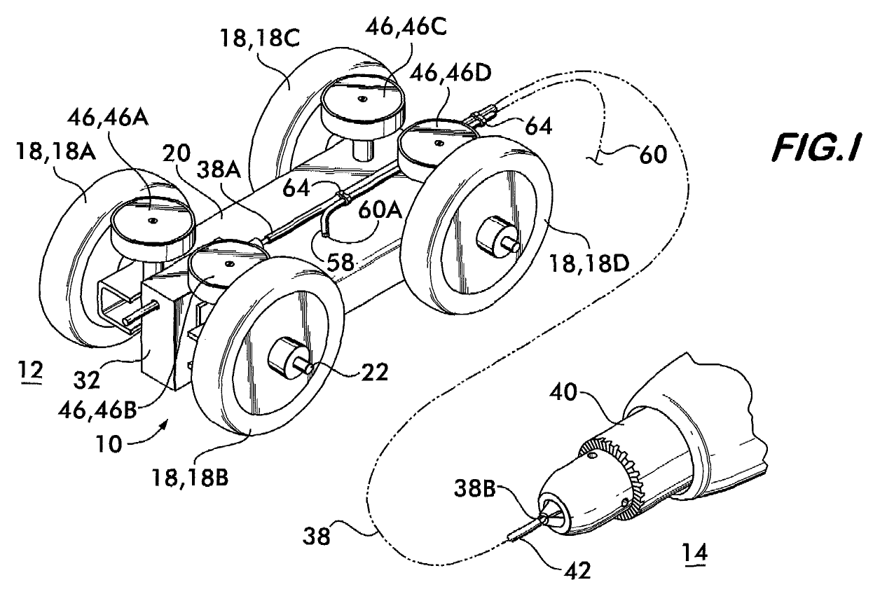

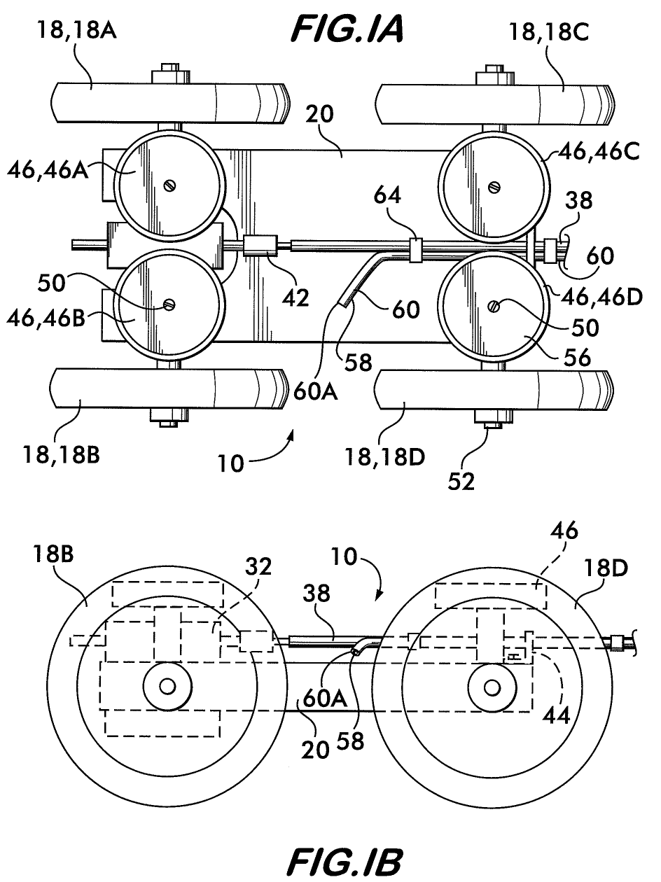

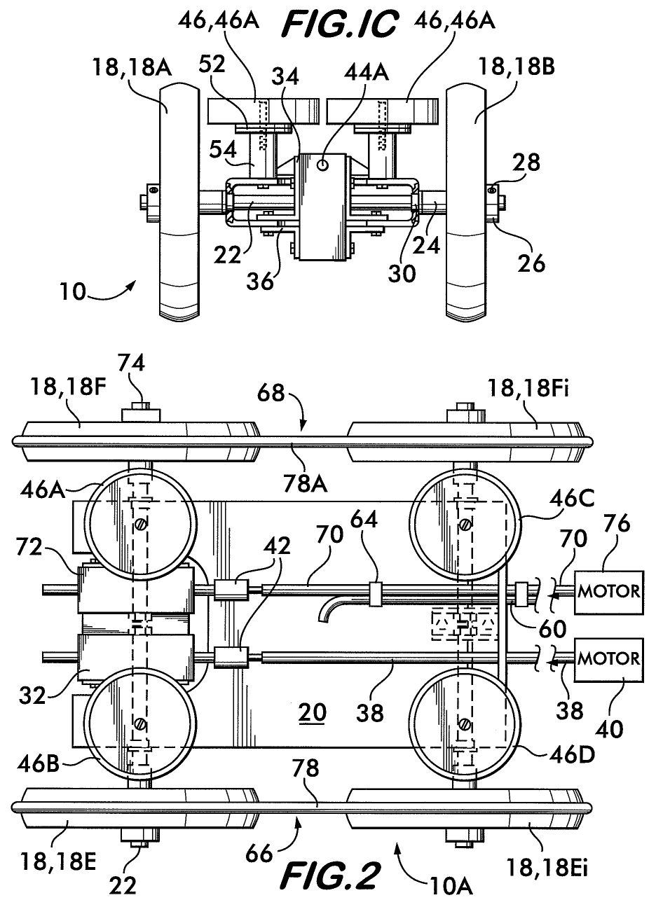

Illustrated in FIGS. 1-1C is one preferred embodiment of a vehicle 10 for use in inspecting a space 12 and which can be operated from a remote location 14. For example, as discussed further below, the space 12 can be any space that may be too hazardous for personnel to enter safely. A rail tank car, being one such example described below, may contain a hazardous atmosphere if it was not properly evacuated. Before sending workers into the rail tank car as may be needed, it is preferable to test the atmosphere within the tank from a location remote from the space to be tested, i.e., a location 14 outside or away from the space which is safe for personnel. The vehicle 10, placed within the space 12, can be operated from the remote location 14, allowing the atmosphere within the space 12 to be tested while the operator of the vehicle 10 remains outside the space 12 in the remote safe location 14. The vehicle 10, driven from the remote location 14, travels over a surface 16 (see, e.g., FIG. 3) within the space 12 on wheels 18 to adequately test the interior atmosphere before people are allowed to enter.

More specifically, the vehicle 10 includes a chassis 20 on which other components of the vehicle 10 can be mounted. The chassis 20 can be formed in any suitable configuration or of any suitable material or structural pieces. In the illustrated embodiment, the chassis 20 is constructed from rectangular tubing formed of aluminum or other lightweight corrosion resistant material.

At least three wheels 18 are rotatably mounted to the chassis 20 allowing the chassis 20 to be moveable over the surface 16. In the illustrated embodiment, four wheels 18 are provided as seen in FIGS. 1 and 1A, the front or driven wheels being referenced as 18A, 18B respectively, the rear or non-driven wheels being referenced as 18C, 18D respectively. The wheels 18 are made of any suitable material and can be chosen for a particular service. For example, if the surface 16 over which the vehicle 10 will travel is glass, e.g., a glass lined tank, the portion of the wheels 18 that contact the surface 16 can include soft rubber. Alternatively, the portion of wheels 18 which contacts a corrosive surface 16 can include Teflon®.

The wheels 18 are attached to the chassis 20 via axles 22 as known in the art. With reference to FIG. 1C showing the front driven wheels 18A, 18B, it is seen that the wheels are attached to and held in place on an axle 22 for rotation therewith by a shaft collar 24 on one side of the wheels 18A, 18B, and a wheel hub 26 on the other side held in place on the axle 22 by a set screw 28. The axle 22 passes through and is mounted to the chassis 20 by axle bearings 30 mounted to the chassis 20 as shown, the bearing 30 being a low friction sleeve in the present embodiment. Any suitable means for attaching the wheels 18 to the chassis 20 may be used.

The non-driven wheels 18C, 18D are connected to the chassis 20 in a similar manner (not shown), although each of these wheels may have its own separate axle 22. These wheels are non-driven and thus are free turning wheels.

A transmission 32 is mounted to chassis 20 and is operatively connected to at least one of the wheels 18 for rotating the wheel 18. In the illustrated embodiment of FIG. 1, the transmission 32 is a sealed gearbox mounted to the chassis 20 and operatively connected to the first and second wheels 18A, 18B via the axle 22 for driving the wheels 18A, 18B at a speed of about 1 foot per second. Transmission 32 is mounted to chassis 20 via upper and lower gearbox mounting brackets 34, 36, respectively. The sealed gearbox is advantageous in that the lubrication sealed within cannot leak and accidentally contaminate the space 12. Other transmissions means may be used as suitable.

A rotatable flexible drive shaft 38 is operatively connectable at one end 38A to the transmission 32 for driving the transmission 32 and thereby rotate the first and second wheels 18A, 18B, and operatively connectable at a second end 38B to a motor 40 for rotating the flexible drive shaft 38. Thus it is seen that rotation of the flexible drive shaft 38 rotates the wheels 18A, 18B to move the vehicle 10 over the surface 16. A quick connect fitting 42 is provided for connecting the flexible drive shaft 38 to the transmission 32. A drive shaft support bracket 44 having an opening 44A through which the flexible drive shaft 38 passes is provided to support the rotatable flexible drive shaft 38 on the chassis 20 (see FIG. 1B). The rotatable flexible drive shaft 38 has sufficient length to drive the vehicle 10 in the space 12 from the remote location 14. The flexible drive shaft 38 can also function as an emergency tether for removing the vehicle 10 from the space 12 should the vehicle 10 become disabled. Suitable rotatable flexible drive shafts 38 for transmitting rotational motion are known in the art, and can include “off the shelf” items which typically come in 25 and 50 foot lengths, made of coiled spring steel which rotates within a protective covering. A rotatable flexible drive shaft provided by Goodway Technologies Corporation, flexible shaft model no. GTC-702-25, has been found suitable.

The motor 40 for powering the vehicle 10 can be any rotational device having sufficient torque to rotate the flexible drive shaft 38 and thereby rotate the wheels 18A, 18B. The length of flexible drive shaft 38 is taken into consideration when choosing a suitable motor 40. For example, higher torque may be needed to rotate a longer flexible drive shaft 38. Preferred motors 40 include fractional horsepower motors, for example, ¼ HP or less, depending on the power needed for the vehicle 10 to travel at a desired speed. Examples of suitable motors 40 include electric motors in hand-held devices, e.g. power tools such as drills (a cordless drill being particularly preferred), pneumatic motors, hydraulic motors, etc. Since the motors 40 are operated from the remote location 14 which is safe, any type of motor 40 can be used with little worry of contaminating the space 12, e.g., possible contamination from the fluids in hydraulic motors, or explosions from electrical motors, although it is likely that explosion proof electric motors will still be required in any chemical plant environment.

At least one magnet 46 is mounted on the chassis 20. The magnet 46 is positioned to magnetically attract a magnetically sensitive material 48 (iron and steel) adjacent the wheels 18 and has sufficient magnetic force to support the full weight of the vehicle 10, e.g., maintain the vehicle 10 in contact with the surface 16 even when the vehicle 10 is beneath and hanging from the surface 16 (see, e.g., FIG. 3). In this example, the surface 16 is made of steel and would be the magnetically sensitive material 48 to which the vehicle 10 is magnetically attracted, or the magnetically sensitive material 48 could be placed on the side of the surface 16 opposite the wheels as further discussed below.

In the illustrated embodiment, the magnet 46 is formed of four flat disc magnets 46A, 46B, 46C, and 46D mounted on chassis 20 via magnet mounting screws 50 inserted through magnet shims 52 (FIG. 1C) and magnet spacers 54 so that a suitable or desired clearance is provided between the magnets 46 and the surface 16 over which the wheels 18 will travel. A suitable preferred clearance is about ⅛″ on a flat surface 16, for a vehicle 10 weighing about 2 lbs, overall width of 7 inches, overall length 12 inches, and where each of the four magnets 46 has a force rating of about 150 to 250 lbs. It is readily understood that the clearance increases when the vehicle 10 travels on a curved surface. Is also understood that the magnetic force drops off quickly as the clearance increases, which must be taken into account when specifying the magnets 46 to be used. Magnet shims 52 are placed at one end of magnet spacers 54 and are used to adjust the clearance of magnets 46. As shown in FIG. 1A, the four flat disk magnets 46 are mounted on chassis 20 just inside each wheel 18 with the center 56 of the disc magnets 46 aligned over the respective axles 22 of the wheels 18. With this arrangement, if wheels 18 travel over an obstacle on the surface 16, such as a weld joint, each of the magnets 46 will move unobstructed with the wheels 18 over the obstacle. Alternatively, one or more wheels 18 could be made of magnetic material.

The vehicle shown in FIGS. 1-1C also includes an inspection device 58 mounted thereto. This can be any device 58 suitable for remote inspection of a space 12. Preferred inspection devices 58 include gas collection tubing, samplers, ultrasound probes, radiographic sources, cameras, water blasters, and abrasive blasters. For example, to sample the atmosphere inside a space 12, a long collection tube 60 can be used (see e.g., FIG. 3). One end of the tube having an intake opening 60A can be mounted to the vehicle 10, and its opposite end 60B connected to an analyzer 62 located outside the space 12 in the remote location 14. Here, the length of sample tubing 60 would be similar to the length of the flexible shaft 38, allowing the tubing 60 to extend from the space 12 to the analyzer 62, and may be bundled with the flexible shaft 38 with some form of fasteners 64.

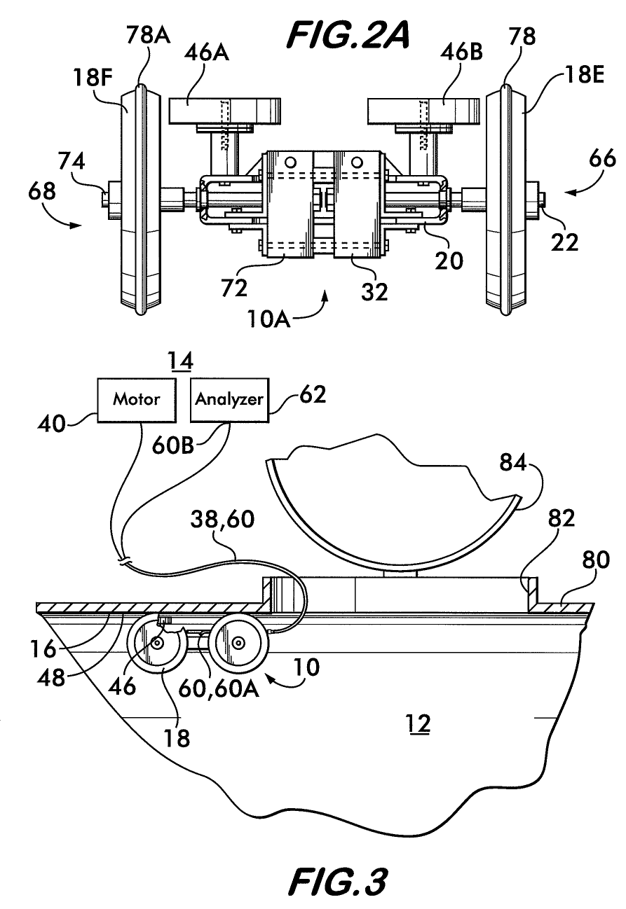

It is appreciated that the vehicle illustrated in FIGS. 1 to 1C is not steerable, and thus will travel back and forth in the direction predetermined by the position of the wheels 18, in this case, a straight line. Thus, rotating the motor 40 in one direction will drive the vehicle 10 in one direction, and reversing the motor 40 will drive the vehicle 10 in the opposite direction. Where desirable, the present invention also provides a steerable vehicle 10A. One embodiment of such a vehicle 10A is now described with further reference to FIGS. 2 and 2A.

Illustrated in FIGS. 2 and 2A is a steerable vehicle 10A which can be used where steering capabilities are desired, such as for avoiding obstacles. It is similar in construction to the vehicle 10 described with reference to FIGS. 1 to 1C, and contains similar components with like reference numbers. The vehicle 10A includes a chassis 20 having a first side 66 and a second side 68 opposite the first side, and four wheels 18. For reference, the wheels 18 include wheels 18E and 18Ei mounted to the chassis 20 on the first side 66, and wheels 18F and 18Fi on the second side 68. A first flexible drive shaft 38 is operatively connectable to a first transmission 32 which in turn is operatively connected to the wheel 18E via the axle 22 to power the wheel 18E. Likewise, a second flexible drive shaft 70 is operatively connectable to a second transmission 72 which in turn is operatively connected to the wheel 18F via the axle 74 to power the wheel 18F. Motors 40 and 76 are connectable to the ends of the respective flexible shafts 38 and 70 opposite the ends connected to the vehicle 10A. Both flexible shafts 38 and 70 have sufficient length so that the vehicle 10A can be operated from the safety of the remote location 14. The axles 22 and 74 are not connected to one another and thus the wheels 18E and 18F can be rotated independently of one another by respective motors 40 and 76. The two flexible drive shafts 38 and 70 can be fastened to one another to prevent the shafts from becoming entwined in a way that compromises the drivability of the vehicle 10A.

In this particular embodiment, all four wheels 18 are driven. As shown in FIG. 2, wheels 18E and 18Ei located on the first side 66 of the vehicle 10A are operatively connected to one another by a flexible tread 78 extending engagingly around a portion of an outer perimeter of wheels 18E and 18Ei. Similarly, wheels 18F and 18Fi located on the second side 68 of the vehicle 10A are operatively connected to one another by second flexible tread 78A. The flexible tread 78 can be formed of an elastomeric band or large O-ring set in a circular slot in the outer perimeter of the wheels 18, although other materials, as well as other suitable means for driving the wheels 18Ei and 18Fi can be used. When the vehicle 10A is in use, the flexible treads 78 contact the surface 16 of the space 12 over which the vehicle 10A travels to provide additional traction for the vehicle 10A. In a manner similar to that of a tractor or a tank, the vehicle 10A can be steered or turned by rotating the wheels 18 on the one side of the vehicle at a different rate than the wheels 18 on the other side. For example, forward (leftward) rotation of wheels 18E and 18Ei while at the same time not rotating the wheels 18F and 18Fi as oriented in FIG. 2 would cause the vehicle 10A to turn to the right (upward). Thus it is seen that a simple steering control is provided by rotating the flexible shafts 38 and 70 differently through control of the motors 40 and 76 from the remote location 14.

Having described vehicles in accordance with the present invention, examples of methods for inspecting a space 12 using such vehicles 10 is now described. With reference to FIG. 3, a vehicle 10, such as that shown in FIGS. 1-1 C or FIGS. 2-2A, is shown within a space 12 inside the tank 80 of a rail tank car, attached to and hanging upside down from a surface 16. The surface 16, here the inside wall of the tank 80, is made of steel to which the magnets 46 of the vehicle 10 are magnetically attracted to support the vehicle 10.

An atmospheric sample tube 60 extends from the vehicle 10, out through the opening 82 to the remote location 14 where the analyzer 62 is positioned. Likewise, a rotatable flexible drive shaft 38 extends from the vehicle 10, out through the opening 82 to the remote location 14 where the motor (drill) 40 can be safely operated by a worker.

With the opening cover 84 opened, the vehicle 10 is placed through the opening 82 (rail car openings are typically 18 inches in diameter) into the space 12. The vehicle 10 is small and light enough for a worker to easily reach in through the opening 82 and place the vehicle 10 inside the tank 80 against the roof surface 16. After entering the space 12, the vehicle 10 is moved in the space 12 by rotating flexible drive shaft 38 from the remote location 14 to drive first wheel 18. The vehicle 10 is moved in a first direction by rotating drive shaft 38 in a first rotational direction, and moved in a second direction opposite the first direction by rotating drive shaft 38 in a second rotational direction opposite the first rotational direction. Samples of the air inside the space are drawn through the sample tube 60 and analyzed by the analyzer 62. After the vehicle 10 is driven inside the space 12 to obtain the desired air samples, the vehicle 10 is driven back to the opening 82 through which it can be removed easily by a worker.

In the above illustrated method, the vehicle 10 was suspended from the roof surface 16 of the tank 80. Driving the vehicle 10 along the roof surface 16 has the advantage of avoiding any potentially corrosive liquids that may have been stored in and not fully evacuated from the tank 80, as well as avoiding any debris that may remain along the bottom surface of the tank. The magnets 46 would not be necessary for driving the vehicle over the bottom surface. Driving the vehicle 10 along the roof surface has the added advantage of allowing the air sampling tube 60 to hang downward from where it is attached to the vehicle 10. In this manner the desired length of sampling tube 60 to hang from the vehicle 10 can be chosen so that the inlet end 60A of the sample tube 60 will be at the desired elevation within the tank 80. For example, if the gas being tested for is lighter than air, it may be preferable to position the sample tube end 60A nearer the roof of the tank 80. Similarly, if the gas being tested for is heavier than air, it may be preferable to position the sample tube end 60A nearer the bottom of the tank 80.

In the above described method, the vehicle 10 maintains contact with surface 16 by magnetic attraction between the vehicle 10 and the magnetically sensitive material 48 adjacent the wheels 18, in this case the metallic surface 16 of the tank 80 itself. In a glass lined steel tank 80, the surface 16 may be glass, but the wall behind the glass provides the magnetically sensitive material 48 adjacent the wheels 18. Stronger magnets 46 may be necessary in such situations due to the greater distance between the magnets 46 and the steel.

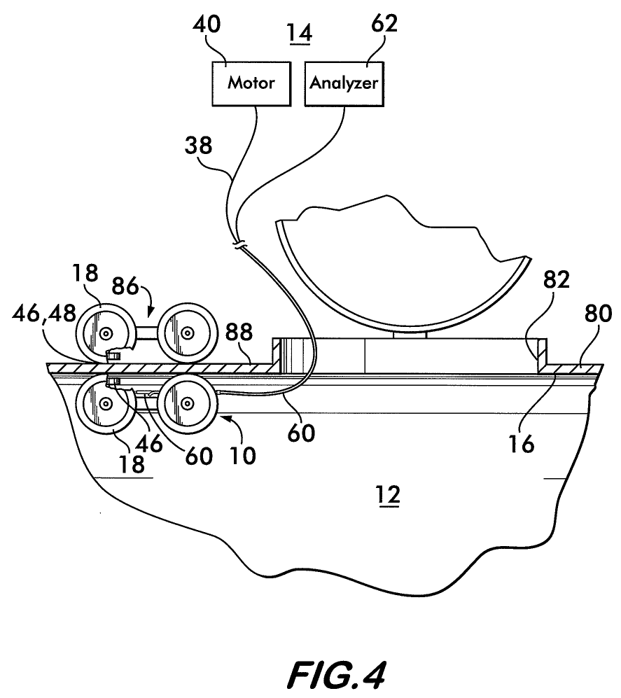

The method illustrated in FIG. 4 is useful where the surface 16 is not magnetically sensitive or near magnetically sensitive material, e.g., an aluminum vessel. Magnetically sensitive material 48 can be positioned on a side of the surface 16 directly opposite from the vehicle 10 such that the magnetic attraction between the vehicle 10 and magnetically sensitive material 48 works through surface 16. In FIG. 4, a vehicle 86 having magnets 46 similar to that described above with reference to FIGS. 1 to 1C, but which has wheels 18 that all move freely in response to movement of the first vehicle 10 is positioned outside the space 12 on the outer wall 88 of the vessel 80 opposite the surface 16. Here, the magnetically sensitive material 48 adjacent to the wheels 18 of the vehicle 10 are the magnets 46 on the vehicle 86. This allows the vehicle 86 to move with and stay directly opposite of the first vehicle 10 to maintain the vehicle 10 against the surface 16 within the space 12.

The inspection device 58 shown in FIG. 4 inspects the atmosphere within the space by drawing atmospheric gases into gas collecting tube 60. A different inspection device 58 could inspect at least a portion of the surface 16.

The vehicle of the present invention presents several advantages over the prior art. The standard materials of construction are resistant to a wide range of corrosive atmospheres and chemicals and can be easily tailored for unique environments. The vehicle contains no electrical or spark generating components that may pose a risk in flammable or explosive atmospheres. Also, the vehicle contains no fluids that can leak and pose environmental hazards. The robust design of the vehicle makes it well-suited for routine use by persons with very minimal training. Furthermore, the simple construction is easily field maintainable by any person of average mechanical aptitude and possessing only common hand tools. Additionally, the use of easily available materials and “off the shelf” components make it possible to construct the device for a fraction of the price for prior art vehicles.

Other embodiments of the present invention include a longer vehicle including additional sets of wheels, such as 6 wheels, to safely traverse obstacles commonly found in tanks and vessels such as nozzles, etc. It is also understood that magnets need not be provided on the vehicles, such as where the vehicle traverses over horizontal spaces.

While the invention has been described with reference to a preferred embodiment, it will be understood by those skilled in the art that various changes may be made and equivalents may be substituted for elements thereof without departing from the scope of the invention. In addition, many modifications may be made to adapt to a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

We claim:

1. A vehicle for use in inspecting a space and which can be operated from a remote location, said vehicle comprising:
a chassis;
at least three wheels rotatably mounted to and on which said chassis is moveable over a surface;
a transmission mounted to said chassis and operatively connected to at least a first one of said wheels for rotating said first wheel; and
a rotatable flexible drive shaft having a first end operatively connectable to said transmission for driving said transmission to rotate said first wheel, and a second end operatively connectable to a motor for rotating said flexible drive shaft and thereby move said vehicle over said surface, said flexible drive shaft having sufficient length to drive said vehicle in the space from the remote location.

2. The vehicle of claim 1 further comprising an axle to which said first wheel is connected for rotation therewith, and wherein said transmission comprises a gearbox connected to said axle so as be operatively connected to said first wheel.

3. The vehicle of claim 2 further comprising a quick connect fitting for connecting said flexible drive shaft to said transmission.

4. The vehicle of claim 1 further comprising at least one magnet mounted to said chassis and positioned to magnetically attract a magnetically sensitive material adjacent said wheels, said magnet having sufficient magnetic force to maintain said vehicle in contact with said surface.

5. The vehicle of claim 4 wherein said magnet comprises multiple magnets.

6. The vehicle of claim 1 wherein said motor comprises an electric motor.

7. The vehicle of claim 1 further comprising an inspection device mounted thereto.

8. The vehicle of claim 1 wherein said inspecting device is selected from the group consisting of gas collection tubing, samplers, ultrasound probes, radiographic sources, cameras, water blasters, and abrasive blasters.

9. The vehicle of claim 1 wherein said vehicle has a first side and a second side opposite said first side, and wherein said first wheel is located on said first side, and said vehicle further comprises:
a second transmission mounted to said chassis and operatively connected to at least a second one of said wheels other than said first wheel for rotating said second wheel, said second wheel being located on said second side of said vehicle; and
a second rotatable flexible drive shaft having one end operatively connectable to said second transmission for driving said second transmission to rotate said second wheel, and a second end operatively connectable to a second motor for rotating said second flexible drive shaft independently of said first flexible drive shaft to allow control of the direction of travel of said vehicle, said second flexible drive shaft having sufficient length to operate said vehicle in the space from the remote location.

10. The vehicle of claim 1 wherein said vehicle has a first side and a second side opposite said first side, and said vehicle further comprises:
at least four wheels, two of said four wheels being located on said first side and the other two of said four wheels being located on said second side, and
wherein said wheels located on said first side are operatively connected so as to be rotatably driven in unison together.

11. The vehicle of claim 10 wherein said two wheels located on said first side of said vehicle are operatively connected to one another by a flexible tread extending engagingly around a portion of an outer perimeter of said two first side wheels.

12. A method for inspecting a space comprising:
(a) placing a vehicle within said space, said vehicle having wheels for moving over a surface within said space and a transmission operatively connected to at least a first one of said wheels;
(b) providing a rotatable flexible drive shaft operatively connected to said transmission for driving said vehicle, said drive shaft having a length sufficient to operate said vehicle within said space from a location remote from said space; and
(c) moving said vehicle within said space by rotating said flexible drive shaft from said remote location to drive said first wheel and carry out the inspection.

13. The method of claim 12 wherein step (c) comprises moving said vehicle in a first direction by rotating said drive shaft in a first rotational direction, and moving said vehicle in a second direction opposite said first direction by rotating said drive shaft in a second rotational direction opposite said first rotational direction.

14. The method of claim 12 wherein the vehicle provided in step (a) further comprises a second transmission operatively connected to a second one of said wheels other than said first wheel and located on a side of said vehicle opposite of said first wheel; and step (c) further comprises turning said vehicle within said space by rotating one of said first and second wheels at a different angular velocity than the other of said first and second wheels.

15. The method of claim 12 further comprising:
(d) maintaining said vehicle in contact with said surface by magnetic attraction between said vehicle and a magnetically sensitive material positioned to urge said vehicle towards said surface.

16. The method of claim 15 wherein said magnetically sensitive material comprises said surface of said space.

17. The method of claim 15 wherein said magnetically sensitive material is positioned on a side of said surface directly opposite from said vehicle such that said magnetic attraction between said vehicle and a magnetically sensitive material works through said surface.

18. The method of claim 17 wherein said magnetically sensitive material is mounted on a second vehicle having wheels to move in response to movement of said first vehicle to stay directly opposite of said first vehicle.

19. The method of claim 12, wherein said vehicle includes an inspection device.

20. The method of claim 19, wherein said inspecting device is selected from the group consisting of gas collection tubing, samplers, ultrasound probes, radiographic sources, cameras, water blasters, and abrasive blasters.
